(19) United States
(12) Patent Application Publication
(10) Pub. No.: US 2016/0077575 A1
(43) Pub. Date: Mar. 17, 2016

(54) INTERFACE TO EXPOSE INTERRUPT TIMES TO HARDWARE

(71) Applicant: Advanced Micro Devices, Inc., Sunnyvale, CA (US)

(72) Inventors: Indrani Paul, Round Rock, TX (US); Manish Arora, Dublin, CA (US)

(21) Appl. No.: 14/488,864

(22) Filed: Sep. 17, 2014

(51) Int. Cl. G06F 1/32

(52) U.S. Cl. CPC G06F 1/3237; G06F 1/3265

(57) ABSTRACT

A power management controller is used to control power management states of a processing device. A register stores a timer tick value accessible to the power management controller. The timer tick value indicates when an interrupt is to occur in the processing device. The power management controller may use the exposed timer tick value to decide whether to transition between power management states such as an active state, an idle state, and a power-gated state. The timer tick value stored in the register may be modified by an operating system, an application, or software implemented on the processing device.

### BACKGROUND

1. Field of the Disclosure

The present disclosure relates generally to processing devices and, more particularly, to interrupt timer values used by operating systems in processing devices.

2. Description of the Related Art

Components in processing devices such as central processing units (CPUs), graphics processing units (GPUs), and accelerated processing units (APUs) can be placed in different performance states such as an active state in which the component is actively performing tasks, an idle state in which the component is not performing tasks, and a power-gated state in which the component is disconnected from a power supply. The components may therefore conserve power by idling (i.e., transitioning from an active state to an idle state) when there are no instructions to be executed by the component of the processing device. If the component is idle for a relatively long time, power supplied to the processing device may be gated so that no current is supplied to the component, thereby reducing stand-by and leakage power consumption. For example, a processor core in a CPU can be power gated if the processor core has been idle for more than a predetermined time interval, which may be determined by the value of a Cache-Flush-on-Halt (CFoH) timer register. However, power gating consumes system resources. For example, power gating requires flushing caches in the processor core and saving state information that defines the state of the processor core prior to power gating. Both processes consume time and power.

Power gating also exacts a performance cost to return the power gated component to an active state. For example, the state information that was stored prior to power gating should be loaded back into the configuration registers of the power gated component before returning the component to the active state. The time required to restore the state of the power gated component adds latency to the activation process, which can also impact the performance of the system. For example, the operating system of the processing device periodically issues interrupts that force the components of the processing device to transition to the active state, regardless of the states of the components prior to the interrupt. The interrupt cannot be serviced by power gated components of the processing device until the power gated components have completed the transition to the active state. Servicing the interrupt may therefore be delayed because transitioning to the active state requires writing state information back into configuration registers associated with the power gated component.

A timer tick value indicates the time interval between interrupts issued by the operating system. The timer tick value is maintained in software by the operating system. Consequently, the timer tick value is not visible to other hardware such as the components of the processing device. Moreover, the timer tick value may be changed in response to requests from applications depending on requirements such as latency tolerance, throughput, frames per second, frame jitter rate, and the like. For example, the default timer tick value for Windows® may be 16 ms but multimedia applications typically request a 1 ms timer tick value. For another example, tick-less operating system such as Linux® may simply check when the interrupt timer is due to expire and then sleep until that time.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing device in accordance with some embodiments.

FIG. 2 is a plot that shows transitions of a component of a processing device between an active state and an idle state according to some embodiments.

FIG. 3 is a plot that shows a transitions of a component of a processing device from an active state to an idle state and back to the active state according to some embodiments.

FIG. 4 is a flow diagram of a method for storing timer tick values in a register according to some embodiments.

FIG. 5 is a flow diagram of a method for deciding whether to power gate an idle component of a processing device according to some embodiments.

FIG. 6 is a flow diagram of a method for determining when to cause a power gated component of a processing device two exit the power gated according to some embodiments.

FIG. 7 is a flow diagram illustrating a method for designing and fabricating an integrated circuit device implementing at least a portion of a component of a processing system according to some embodiments.

### DETAILED DESCRIPTION

Power gated components of a processing device may be awakened to transition to the active state “just-in-time” to service operating system interrupts by exposing the timer tick value used by the operating system to a hardware controller such as a system management unit or a power management unit. In some embodiments, the operating system stores the timer tick value in a model specific register or a configuration register that is accessible to other hardware components. The hardware controller can then instruct power gated components to transition to the active state before the operating system issues an interrupt at the time determined by the timer tick value. Some embodiments of the hardware controller may instruct the power gated components to transition to the active state at a time that is determined by the timer tick value and an expected latency for the transition. The hardware controller may also decide whether to power gate an idle component of the processing device based on the timer tick value because the timer tick value sets an upper limit on the duration of the power gated state. For example, the hardware controller may compare the costs and benefits of power gating a component for a time interval between the current time and the time that the next interrupt will be issued. The component may then be power gated if the benefits exceed the costs and power gating may be bypassed if the costs exceed the benefits. Some embodiments of the hardware controller may also set the idle time interval that expires before power gating, e.g., the value of a Cache-Flush-on-Halt timer register, based on the timer tick value.

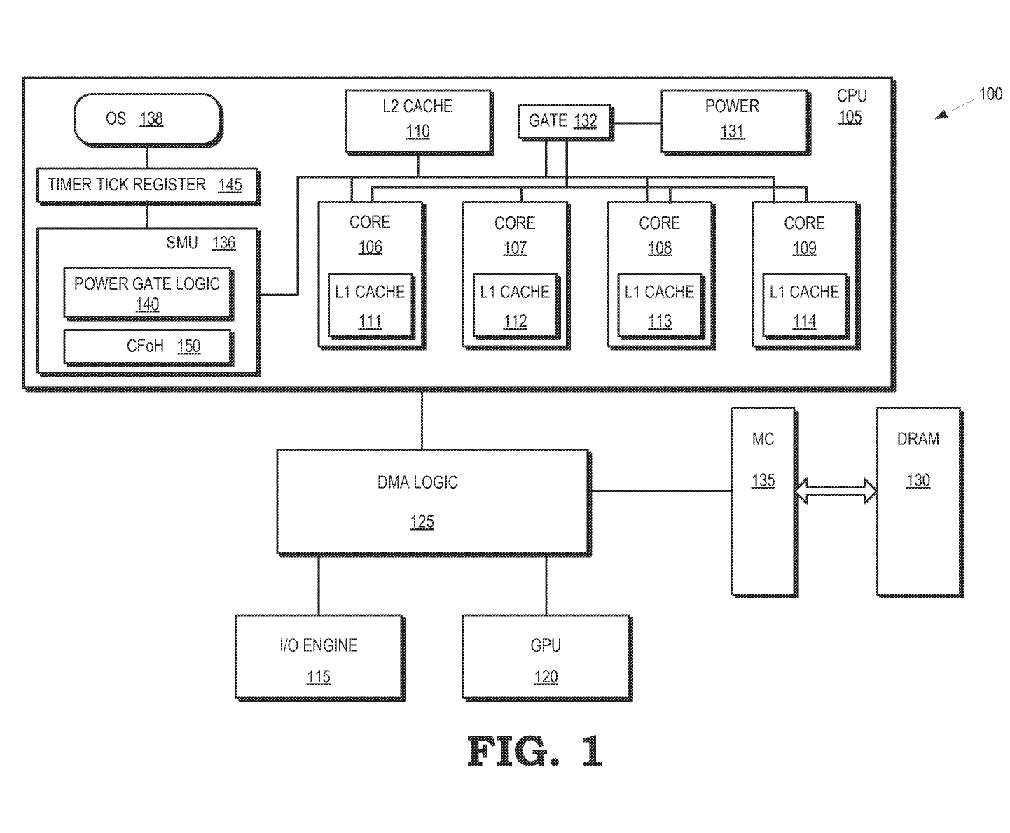

FIG. 1 is a block diagram of a processing device 100 in accordance with some embodiments. The processing device 100 includes a central processing unit (CPU) 105 for executing instructions. Some embodiments of the CPU 105 include multiple processor cores 106-109 that can independently execute instructions concurrently or in parallel. The CPU 105 shown in FIG.1 includes four processor cores 106-109. However, persons of ordinary skill in the art having benefit of the present disclosure should appreciate that the number of processor cores in the CPU 105 is a matter of design choice. Some embodiments of the CPU 105 may include more or fewer than the four processor cores 106-109 shown in FIG. 1.

The CPU 105 implements caching of data and instructions and some embodiments of the CPU 105 may therefore implement a hierarchical cache system. For example, the CPU 105 may include an L2 cache 110 for caching instructions or data that may be accessed by one or more of the processor cores 106-109. Each of the processor cores 106-109 may also implement an L1 cache 111-114. Some embodiments of the L1 caches 111-114 may be subdivided into an instruction cache and a data cache.

The processing device 100 includes an input/output engine 115 for handling input or output operations associated with elements of the processing device such as keyboards, mice, printers, external disks, and the like. A graphics processing unit (GPU) 120 is also included in the processing device 100 for creating visual images intended for output to a display, e.g., by rendering the images on a display at a frequency determined by a rendering rate. Some embodiments of the GPU 120 may include multiple cores, a video frame buffer, or cache elements that are not shown in FIG. 1 interest of clarity.

The processing device 100 shown in FIG. 1 also includes direct memory access (DMA) logic 125 for generating addresses and initiating memory read or write cycles. The CPU 105 may initiate transfers between memory elements in the processing device 100 such as the DRAM memory 130 and/or other entities connected to the DMA logic 125 including the CPU 105, the I/O engine 115 and the GPU 120. Some embodiments of the DMA logic 125 may also be used for memory-to-memory data transfer or transferring data between the cores 106-109. The CPU 105 can perform other operations concurrently with the data transfers being performed by the DMA logic 125 which may provide an interrupt to the CPU 105 to indicate that the transfer is complete. A memory controller (MC) 135 may be used to coordinate the flow of data between the DMA logic 125 and the DRAM 130.

Some embodiments of the CPU 105 may implement a system management unit (SMU) 136 that may be used to carry out policies set by an operating system (OS) 138 of the CPU 105. The OS 138 may be implemented using one or more of the processor cores 106-109. Some embodiments of the SMU 136 may be used to manage thermal and power conditions in the CPU 105 according to policies set by the OS 138 and using information that may be provided to the SME 136 by the OS 138, such as power consumption by entities within the CPU 105 or temperatures at different locations within the CPU 105. The SMU 136 may therefore be able to control power supplied to entities such as the cores 106-109, as well as adjusting operating points of the cores 106-109, e.g., by changing an operating frequency or an operating voltage supplied to the cores 106-109. The SMU 136 or portions thereof may therefore be referred to as a power management unit in some embodiments.

The SMU 136 can initiate transitions between power management states of the components of the processing device 100 such as the CPU 105, the GPU 120, or the cores 106-109 to conserve power or enhance performance. Exemplary power management states may include an active state, an idle state, a power-gated state, or other power management states in which the component may consume more or less power. Some embodiments of the SMU 136 determine whether to initiate transitions between the power management states by comparing the performance or power costs of the transition with the performance gains or power savings of the transition. Some embodiments of the SMU 136 may implement power gate logic 140 that is used to decide whether to transition between power management states. For example, the power gate logic 140 can be used to determine whether to power gate components of the processing device 100 such as the CPU 105, the GPU 120, or the L2 cache 110, as well as components at a finer level of granularity such as the processor cores 106-109, caches 111-114, or cores within the GPU 120. However, persons of ordinary skill in the art should appreciate that some embodiments of the processing device 100 may implement the power gate logic 140 in other locations. Portions of the power gate logic 140 may also be distributed to multiple locations within the processing device 100.

Transitions may occur from higher to lower power management states or from lower to higher power management states. For example, some embodiments of the processing device 100 include a power supply 131 that is connected to gate logic 132. The gate logic 132 can control the power supplied to the cores 106-109 and can gate the power provided to one or more of the cores 106-109, e.g., by opening one or more circuits to interrupt the flow of current to one or more of the cores 106-109 in response to signals or instructions provided by the SMU 136 or the power gate logic 140. The gate logic 132 can also re-apply power to transition one or more of the cores 106-109 out of the power-gated state to an idle or active state, e.g., by closing the appropriate circuits. However, power gating components of the processing device 100 consumes system resources. For example, power gating the CPU 105 or the cores 106-109 may require flushing some or all of the L2 cache 110 and the L1 caches 111-114.

Transitions between power management states may also be triggered by interrupts issued by the OS 138. Some embodiments of the OS 138 may set a timer tick value to indicate when the next interrupt is scheduled to occur. For example, the timer tick value may be set to 15.6 ms so that the OS 138 issues an interrupt every 15.6 ms. Processing devices should be in an active state to service interrupts issued by the OS 138 and so the interrupts cause the CPU 105 (or other entities within the processing device 100) to transition into the active state regardless of their power management state prior to the interrupt. For example, power gated components may transition to the active state in response to interrupts issued by the OS 138. In some embodiments, the timer tick value used in the processing device 100 may be set by applications running in the processing device 100 or other software, firmware, or hardware.

The timer tick value is exposed to hardware in the processing device 100 by storing the timer tick value in a timer tick register 145. As used herein, the term “timer tick value” refers to any value that indicates when the next interrupt is scheduled or expected to be issued. Thus, the timer tick value may indicate the time at which periodic interrupts are issued or the next time an interrupt is expected to be issued by a so-called “tick less” operating system that issues interrupts when an internal timer expires. The timer tick value may be stored in a format that indicates an absolute time in clock cycles or seconds, a relative time in clock cycles or seconds, a duration in clock cycles or seconds, or other format that can be used to determine when a subsequent interrupt is scheduled or expected to be issued by the OS 138. The SMU 136 (and possibly other entities in the processing device 100) can access the timer tick value from the timer tick register 145 and use this information to make power management decisions because the timer tick value sets an upper limit for the time a component of the processing device 100 can remain in an idle state or a power gated state before the interrupt causes the component to transition back into the active state. For example, in response to the processor core 106 entering the idle state, the SMU 136 can decide whether to power gate the processor core 106 based on the time remaining before the next interrupt.

Some embodiments of the SMU 136 may also include a timer and a timer register that indicate how long a component should remain idle before the power gate logic 140 power gates the idle component. The timer and the timer register may be referred to as a Cache-Flush-on-Hold (CFoH) timer and CFoH timer register and these entities are collectively indicated by the box labelled CFoH 150 in FIG. 1. The SMU 136 may set the value of the timer register based on the timer tick value in the timer tick register 145. For example, if the timer tick value indicates that a relatively long time interval will elapse before the next interrupt, the SMU 136 may set the value of the timer register to a relatively low value so that idle components transition to the power gated state after a relatively short time interval. Setting the value of the timer register to the relatively low value may therefore allow the idle component to save more power by staying in the power gated state for a relatively long time interval.

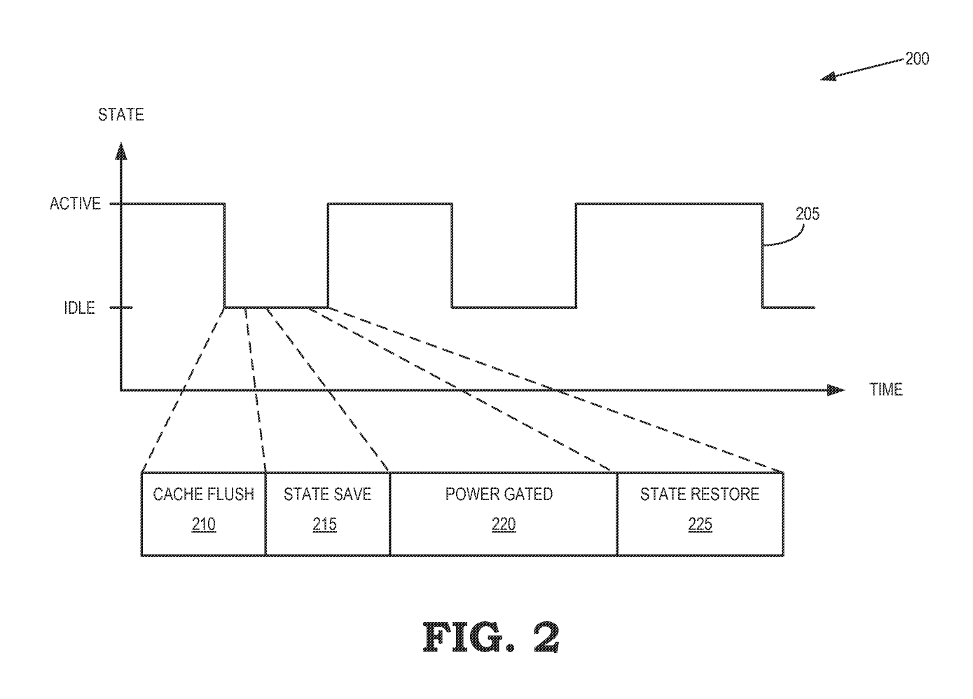

FIG. 2 is a plot 200 that shows transitions of a component of a processing device between an active state and an idle state according to some embodiments. The vertical axis in FIG. 2 shows the performance state of the component (e.g., active or idle) and the vertical axis indicates time, which increases from left to right. The line 205 indicates the performance state as a function of time and shows examples of transitions between the performance states. Some embodiments of the component may be power gated in response to the component transitioning from the active state to the idle state. The power gating overhead includes the resources used during a cache flush 210 of caches such as the caches 110-114 shown in FIG. 1. The power gating overhead also includes resources used to save (at 215) information that is used to define the operating state of the processor core. For example, values in registers in the processor core may be saved to an external memory such as the DRAM 130 shown in FIG. 1. Power may be saved during the power gated state 220 since substantially no power is being supplied to the processor core.

Reentering the active state (at 225) after being power gated also consumes significant resources. For example, resources are consumed to restore the operating state of the processor core, e.g., by writing stored register values from the external memory back into the registers of the processor core. As discussed herein, transitions into the active state may be triggered by an interrupt provided by an operating system in the processing device. At any given time, the next interrupt is indicated by the timer tick value, which sets an upper limit on the duration of the idle or power gated states. The power that may be saved during the power gated state 220 may therefore be estimated by assuming that the duration of the idle state and power gated state is determined by a time at which the component enters the idle state and a time at which the next interrupt occurs, as indicated by the timer tick value. The resource savings resulting from power gating one or more components can then be weighed against the resource cost of power gating these components and subsequently reentering the active state before deciding whether to power gate the component(s) or maintain or reenter the idle or active state.

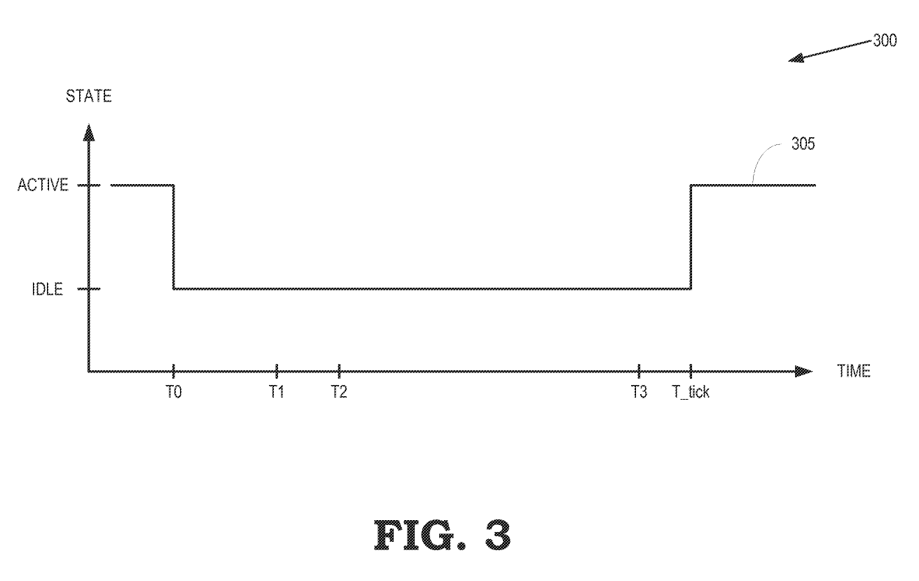

FIG. 3 is a plot 300 that shows a transitions of a component of a processing device from an active state to an idle state and back to the active state according to some embodiments. The vertical axis in FIG. 3 shows the performance state of the component (e.g., active or idle) and the vertical axis indicates time, which increases from left to right. The line 305 indicates the performance state as a function of time and shows examples of transitions between the performance states.

At a time T<T0, the component of the processing device is in the active state. For example, the component may be executing instructions, servicing one or more interrupts, or performing other tasks.

At T=T0, the component of the processing device transitions from the active state to an idle state. For example, the component may no longer be executing instructions or performing other tasks and so a power management unit may decide to conserve power by placing the component in the idle state. Additional power savings may be achieved by power gating the component and so the power management unit initiates power gating of the component in response to the component transitioning into the idle state.

At T0<T<T1, a cache flush is performed to flush any caches associated with the idle component prior to power gating the idle component.

At T1<T<T2, a state save operation is performed to save information in configuration registers that define the state of the idle component prior to power gating the idle component. Although the state save operation shown in FIG. 3 is performed following the cache flush, some embodiments may perform these operations in a different order or concurrently.

At T=T2, the idle component is power gated by decoupling a power supply from the component.

At T2<T<T3, the component is in the power-gated state. During this time interval or during earlier time intervals, the power management unit can access the register including a timer tick value (T_tick) that indicates when the next interrupt is to be issued by the operating system. As discussed herein, the component needs to be in the active state to service the interrupt. Since it takes a finite amount of time to awaken the power gated component, the power management unit can determine a time T3 at which the component should be awakened so that the component is in the active state prior to the operating system issuing the next interrupt at T=T_tick. The time T3 can be determined so that the component is awakened “just-in-time” to service the interrupt.

At T3<T<T_tick, the component transitions from the power gated state to the active state.

At T=T_tick, the operating system issues an interrupt. The component is in the active state and can therefore service the interrupt immediately. The performance of the component is therefore enhanced because the processing device does not have to wait for the component to transition from the power gated state to the active state before servicing the interrupt.

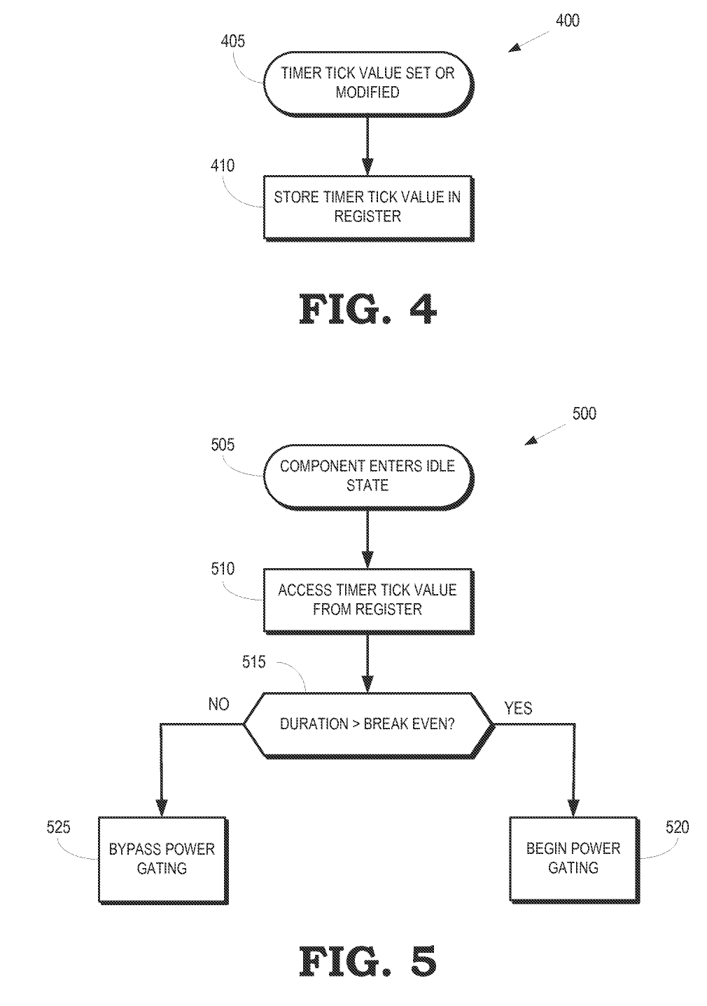

FIG. 4 is a flow diagram of a method 400 for storing timer tick value is in a register according to some embodiments. At block 405, a timer tick value is set or modified. For example, the timer tick value may be set by an operating system to a predetermined value such as 15.6 ms. The timer tick value may also be modified by the operating system, an application, or other software, firmware, or hardware. For example, a multimedia application running on a GPU may modify the timer tick value to 1 ms. The timer tick value may also be set or in response to requests from applications depending on requirements such as latency tolerance, throughput, frames per second, frame jitter rate, and the like. At block 410, the timer tick value is written into a register such as the timer tick register 145 shown in FIG. 1.

FIG. 5 is a flow diagram of a method 500 for deciding whether to power gate an idle component of a processing device according to some embodiments. Some embodiments of the method 500 may be implemented in a system management unit or power management unit such as the SMU 136 or the power gate logic 140 shown in FIG. 1. At block 505, the component enters the idle state. At block 510, the system management unit accesses the timer tick value from a register such as the timer tick register 145 shown in FIG. 1.

At decision block 515, the system management unit uses the timer tick value to compare an estimated duration of the power gated state to a breakeven duration. For example, the system management unit may estimate the duration of the power gated state based on a difference between the current time and the time at which the next interrupt is scheduled or expected to be issued, as indicated by the timer tick value. A system management unit may also estimate the duration of the power gated state based on estimates of the time required for a cache flush, a state save, or a state restore that may be performed prior to the next interrupt. The estimated duration of the power gated state may then be compared to a breakeven duration. In some embodiments, the breakeven duration is equal to the duration at which the resource cost of power gating a component is equal to the resource savings (or other benefits) that would result from power gating the component for the breakeven duration. The breakeven duration may therefore be determined on a component-by-component basis and may be determined using empirical studies, performance testing, modeling, or other techniques. A net resource savings may result if the estimated duration of the power gated state is greater than the breakeven duration. The processing device may therefore begin power gating the component at 520 if the predicted duration is greater than the breakeven duration. If not, the processing device may bypass or turn off power gating the component at 525.

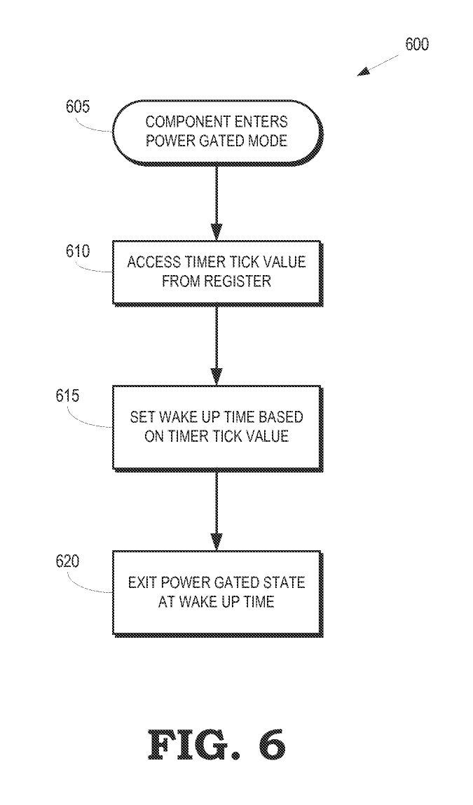

FIG. 6 is a flow diagram of a method 600 for determining when to instruct a power gated component of a processing device to exit the power gated according to some embodiments. Some embodiments of the method 600 may be implemented in a system management unit or power management unit such as the SMU 136 or the power gate logic 140 shown in FIG. 1. At block 605, the component enters the power gated state. At block 610, the system management unit accesses the timer tick value from a register such as the timer tick register 145 shown in FIG. 1. At block 615, the system management unit sets a wake-up time for the component based on the timer tick value. For example, the wake-up time may be set to a time that is earlier than the time at which the next interrupt is scheduled or expected to be issued, as indicated by the timer tick value. The difference between the wake-up time and the interrupt time may be set approximately equal to or slightly longer than an estimated time to transition the component from the power gated state to the active state, e.g., by restoring the previously stored state of the component. At block 620, the system management unit initiates exit from the power gated state at the wake-up time.

In some embodiments, the apparatus and techniques described above are implemented in a system comprising one or more integrated circuit (IC) devices (also referred to as integrated circuit packages or microchips), such as the accelerated processing unit described above with reference to FIGS. 1-6. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

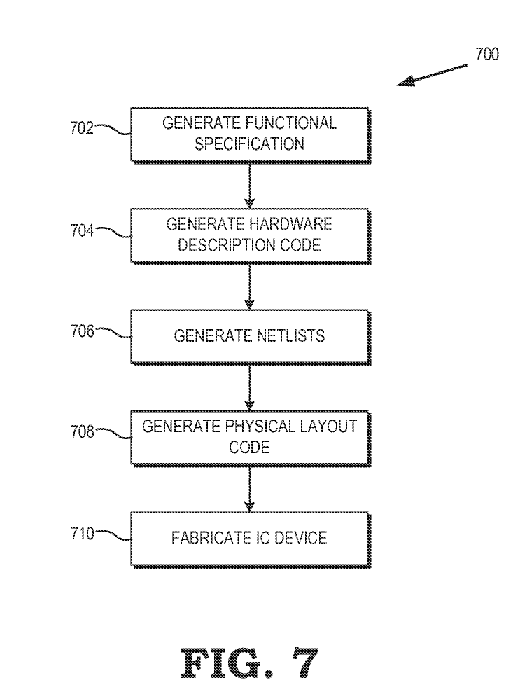

FIG. 7 is a flow diagram illustrating an example method 700 for the design and fabrication of an IC device implementing one or more aspects in accordance with some embodiments. As noted above, the code generated for each of the following processes is stored or otherwise embodied in non-transitory computer readable storage media for access and use by the corresponding design tool or fabrication tool.

At block 702 a functional specification for the IC device is generated. The functional specification (often referred to as a micro architecture specification (MAS)) may be represented by any of a variety of programming languages or modeling languages, including C, C++, SystemC, Simulink, or MATLAB.

At block 704, the functional specification is used to generate hardware description code representative of the hardware of the IC device. In some embodiments, the hardware description code is represented using at least one Hardware Description Language (HDL), which comprises any of a variety of computer languages, specification languages, or modeling languages for the formal description and design of the circuits of the IC device. The generated HDL code typically represents the operation of the circuits of the IC device, the design and organization of the circuits, and tests to verify correct operation of the IC device through simulation. Examples of HDL include Analog HDL (AHDL), Verilog HDL, SystemVerilog HDL, and VHDL. For IC devices implementing synchronized digital circuits, the hardware descriptor code may include register transfer level (RTL) code to provide an abstract representation of the operations of the synchronous digital circuits. For other types of circuitry, the hardware descriptor code may include behavior-level code to provide an abstract representation of the circuitry's operation. The HDL model represented by the hardware description code typically is subjected to one or more rounds of simulation and debugging to pass design verification.

After verifying the design represented by the hardware description code, at block 706 a synthesis tool is used to synthesize the hardware description code to generate code representing or defining an initial physical implementation of the circuitry of the IC device. In some embodiments, the synthesis tool generates one or more netlists comprising circuit device instances (e.g., gates, transistors, resistors, capacitors, inductors, diodes, etc.) and the nets, or connections, between the circuit device instances. Alternatively, all or a portion of a netlist can be generated manually without the use of a synthesis tool. As with the hardware description code, the netlists may be subjected to one or more test and verification processes before a final set of one or more netlists is generated.

Alternatively, a schematic editor tool can be used to draft a schematic of circuitry of the IC device and a schematic capture tool then may be used to capture the resulting circuit diagram and to generate one or more netlists (stored on a computer readable media) representing the components and connectivity of the circuit diagram. The captured circuit diagram may then be subjected to one or more rounds of simulation for testing and verification.

At block 708, one or more EDA tools use the netlists produced at block 706 to generate code representing the physical layout of the circuitry of the IC device. This process can include, for example, a placement tool using the netlists to determine or fix the location of each element of the circuitry of the IC device. Further, a routing tool builds on the placement process to add and route the wires needed to connect the circuit elements in accordance with the netlist(s). The resulting code represents a three-dimensional model of the IC device. The code may be represented in a database file format, such as, for example, the Graphic Database System II (GDSII) format. Data in this format typically represents geometric shapes, text labels, and other information about the circuit layout in hierarchical form.

At block 710, the physical layout code (e.g., GDSII code) is provided to a manufacturing facility, which uses the physical layout code to configure or otherwise adapt fabrication tools of the manufacturing facility (e.g., through mask works) to fabricate the IC device. That is, the physical layout code may be programmed into one or more computer systems, which may then control, in whole or part, the operation of the tools of the manufacturing facility or the manufacturing operations performed therein.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
storing a timer tick value in a register accessible to a power management controller in a processing device, wherein the timer tick value indicates when an interrupt is to occur in the processing device.

2. The method of claim 1, further comprising:
instructing at least one component of the processing device to transition out of a power gated state at a transition time indicated by the timer tick value stored in the register.

3. The method of claim 2, wherein instructing the at least one component of the processing device to transition out of the power gated state comprises instructing the at least one component of the processing device to transition from the power gated state to an active state sufficiently prior to the interrupt occurring in the processing device so that the at least one component is in the active state prior to the interrupt.

4. The method of claim 1, further comprising:
comparing costs and benefits of power gating at least one component of the processing device for a time interval between a current time and a time indicated by the timer tick value; and
power gating the at least one component in response to the benefits of power gating exceeding the costs.

5. The method of claim 1, further comprising:
setting a timer based on the timer tick value stored in the register, wherein the timer is started in response to at least one component of the processing device entering an idle state, and wherein the at least one component of the processing device is power gated in response to the timer expiring.

6. The method of claim 1, wherein storing the timer tick value in the register comprises storing the timer tick value in the register in response to the timer tick value being modified by at least one of an operating system, an application, and software implemented on the processing device.

7. The method of claim 1, further comprising
configuring at least one of a rendering rate and a video frame buffer used by a graphics processing unit in the processing device based on the timer tick value stored in the register.

8. An apparatus comprising:
a power management controller to control power management states of a processing device; and
a register to store a timer tick value accessible to the power management controller, wherein the timer tick value indicates when an interrupt is to occur in the processing device.

9. The apparatus of claim 8, further comprising:
at least one component of the processing device, and wherein the power management controller is to instruct the at least one component to transition out of a power gated state at a transition time indicated by the timer tick value stored in the register.

10. The apparatus of claim 9, wherein the power management controller is to instruct the at least one component of the processing device to transition from the power gated state to an active state sufficiently prior to the interrupt occurring in the processing device so that the at least one component is in the active state prior to the interrupt.

11. The apparatus of claim 8, wherein the power management controller is to compare costs and benefits of power gating at least one component of the processing device for a time interval between a current time and a time indicated by the timer tick value, and wherein the power management controller is to power gate the at least one component in response to the benefits of power gating exceeding the costs.

12. The apparatus of claim 8, wherein the power management controller is to set a timer based on the timer tick value stored in the register, wherein the timer is started in response to at least one component of the processing device entering an idle state, and wherein the at least one component of the processing device is power gated in response to the timer expiring.

13. The apparatus of claim 8, wherein the timer tick value is stored in the register in response to the timer value being modified by at least one of an operating system, an application, and software implemented on the processing device.

14. The apparatus of claim 8, further comprising
a graphics processing unit in the processing device, wherein at least one of a rendering rate and a video frame buffer used by the graphics processing unit is to be configured based on the timer tick value stored in the register.

15. A non-transitory computer readable medium embodying a set of executable instructions, the set of executable instructions to manipulate at least one processor to:
store a timer tick value in a register accessible to a power management controller in a processing device, wherein the timer tick value indicates when an interrupt is to occur in the processing device.

16. The non-transitory computer readable medium of claim 15, the set of executable instructions to manipulate the at least one processor to:
instruct at least one component of the processing device to transition out of a power gated state at a transition time indicated by the timer tick value stored in the register.

17. The non-transitory computer readable medium of claim 15, the set of executable instructions to manipulate the at least one processor to:
compare costs and benefits of power gating at least one component of the processing device for a time interval between a current time and a time indicated by the timer tick value; and
power gate the at least one component in response to the benefits of power gating exceeding the costs.

18. The non-transitory computer readable medium of claim 15, the set of executable instructions to manipulate the at least one processor to:
set a timer based on the timer tick value stored in the register, wherein the timer is started in response to at least one component of the processing device entering an idle state, and wherein the at least one component of the processing device is power gated in response to the timer expiring.

19. The non-transitory computer readable medium of claim 15, the set of executable instructions to manipulate the at least one processor to:
store the timer tick value in the register in response to the timer tick value being modified by at least one of an operating system, an application, and software implemented on the processing device.

20. The non-transitory computer readable medium of claim 15, the set of executable instructions to manipulate the at least one processor to:
configure at least one of a rendering rate and a video frame buffer used by a graphics processing unit in the processing device based on the timer tick value stored in the register.
